(19) United States
(12) Patent Application Publication
(10) Pub. No.: US 2023/0267785 A1
(43) Pub. Date: Aug. 24, 2023

(54) INFORMATION PROCESSING DEVICE, INFORMATION PROCESSING SYSTEM, AND USER TERMINAL

(71) Applicant: TOYOTA JIDOSHA KABUSHIKI KAISHA, Aichi-ken (JP)

(72) Inventor: Keizoh KAWAGUCHI, Okazaki-shi (JP)

(21) Appl. No.: 18/069,907

(22) Filed: Dec. 21, 2022

(30) Foreign Application Priority Data
Feb. 22, 2022 (JP) 2022-025404

(51) Int. Cl. G07C 9/00

(52) U.S. Cl. CPC G07C 9/00182; G07C 2009/00769; G07C 2009/00261

(57) ABSTRACT

An information processing device includes a processor. The processor detects start of a first application program in a user terminal. The first application program is used to perform a remote operation of a vehicle. The processor is configured to transmit, when the start is detected, an instruction signal to a communication terminal of the vehicle. The instruction signal causes one or more electronic control units mounted on the vehicle to transition from a sleep state to an activated state.

### CROSS-REFERENCE TO RELATED APPLICATION

This application claims priority to Japanese Patent Application No. 2022-025404 filed on Feb. 22, 2022, incorporated herein by reference in its entirety.

### BACKGROUND

### 1. Technical Field

The present disclosure relates to an information processing device, an information processing system, and a user terminal.

### 2. Description of Related Art

A technique of performing a remote operation to lock and unlock doors of a vehicle, open and close windows of a vehicle, etc. through an application program installed in a user terminal such as a smartphone is known (see Japanese Unexamined Patent Application Publication No. 2006-316434 (JP 2006-316434 A), for example).

### SUMMARY

An object of the present disclosure is to provide a technique of reducing the delay in a vehicle responding to a remote operation.

A first aspect of the present disclosure provides an information processing device including a processor configured as follows. The processor is configured to detect start of a first application program in a user terminal. Here, the first application program is used to perform a remote operation of a vehicle. Further, the processor is configured to transmit, when the start of the first application program is detected, an instruction signal to a communication terminal of the vehicle. The instruction signal causes one or more electronic control units mounted on the vehicle to transition from a sleep state to an activated state.

With such a configuration, it is possible to reduce the delay in a response of the vehicle to a remote operation.

In the information processing device according to the above first aspect, the processor may be configured to detect the start of the first application program based on a first signal transmitted from the user terminal to the information processing device. Here, the first signal may be transmitted from the user terminal to the information processing device when the first application program is started.

With such a configuration, the processor can immediately detect start of the first application program when the first application program is started in the user terminal. Thus, one or more ECUs are caused to immediately transition from the sleep state to the activated state.

The information processing device according to the above first aspect may further include a storage unit configured to store information that indicates corresponding between the user terminal and the vehicle to each other. Here, the processor may be configured to specify the vehicle corresponded to the user terminal based on the information stored in the storage unit when the information processing device receives the first signal transmitted from the user terminal. Further, the processor may be configured to transmit the instruction signal to the communication terminal of the specified vehicle.

With such a configuration, the processor can cause the electronic control unit of the vehicle corresponding to the user terminal in which the first application program has been started to transition from the sleep state to the activated state at the timing when the first application program is started, even when there is a plurality of combinations of a user terminal and a vehicle.

In the information processing device according to the above first aspect, the processor may be configured to transmit, after transmitting the instruction signal to the communication terminal and when the information processing device receives a second signal that requests a remote operation of the vehicle from the user terminal, the second signal for requesting the remote operation of the vehicle to the communication terminal of the vehicle linked to the user terminal.

With such a configuration, it is possible to transmit the second signal to the communication terminal of the vehicle in which the electronic control unit has transitioned from the sleep state to the activated state.

In the information processing device according to the above first aspect, the one or more electronic control units may be configured to include an electronic control unit that controls a power window actuator of the vehicle.

In the information processing device according to the above first aspect, the one or more electronic control units may be configured to include an electronic control unit that controls an air conditioning device of the vehicle.

In the information processing device according to the above first aspect, the one or more electronic control units may be configured to include an electronic control unit that controls a door lock actuator of the vehicle.

In the information processing device according to the above first aspect, the one or more electronic control units may be configured to include an electronic control unit that controls charge of a battery of the vehicle.

In the information processing device according to the above first aspect, the one or more electronic control units may be configured to include an electronic control unit that controls a hazard lamp of the vehicle.

In the information processing device according to the above first aspect, the one or more electronic control units may be configured to include an electronic control unit that controls an alarming horn of the vehicle.

With such a configuration, it is possible to reduce the delay in a response to a remote operation that is at least one of a remote operation of the power window actuator, a remote operation of the air conditioning device, a remote operation of the door lock actuator, a remote operation of charge of the battery, a remote operation of the hazard lamp, a remote operation of the alarming horn, etc.

A second aspect of the present disclosure provides an information processing system including: a user terminal configured such that a first application program to be used to perform a remote operation of a vehicle is installed; a server device configured to communicate with the user terminal; and a communication terminal mounted on the vehicle and configured to communicate with the server device. The user terminal is configured to transmit a first signal to the server device when the first application program is started. The server device is configured to detect start of the first application program based on the first signal, and the server device is further configured to transmit an instruction signal that causes one or more electronic control units mounted on the vehicle to transition from a sleep state to an activated state to the communication terminal of the vehicle when the start of the first application program is detected. The communication terminal is configured to transmit a signal for causing the one or more electronic control units to transition from the sleep state to the activated state to the one or more electronic control units when the instruction signal is received.

In the information processing system according to the above second aspect, the server device may be configured to further include a storage unit that stores information that indicates corresponding between the user terminal and the vehicle to each other. The server device may be configured to specify the vehicle corresponded to the user terminal based on the information stored in the storage unit when the first signal is received. The server device may be configured to transmit the instruction signal to the communication terminal of the specified vehicle.

In the information processing system according to the above second aspect, the user terminal may be configured to receive an operation by a user to request a remote operation of the vehicle after transmitting the first signal. The user terminal may be configured to transmit a second signal that requests the remote operation of the vehicle to the server device. The server device may be configured to transmit, upon receiving the second signal from the user terminal, the second signal for requesting the remote operation of the vehicle to the communication terminal of the vehicle corresponded to the user terminal. The communication terminal may be configured to transmit, upon receiving the second signal, a signal that requests an operation corresponding to the remote operation to the one or more electronic control units.

In the information processing system according to the above second aspect, the remote operation requested by the user may be an operation of a power window of the vehicle; and the one or more electronic control units may include an electronic control unit that controls a power window actuator of the vehicle.

In the information processing system according to the above second aspect, the remote operation requested by the user may be an operation of an air conditioning device of the vehicle; and the one or more electronic control units may include an electronic control unit that controls the air conditioning device.

In the information processing system according to the above second aspect, the remote operation requested by the user may be an operation to lock or unlock a door of the vehicle; and the one or more electronic control units may include an electronic control unit that controls a door lock actuator of the vehicle.

In the information processing system according to the above second aspect, the remote operation requested by the user may be an operation to charge a battery of the vehicle; and the one or more electronic control units may include an electronic control unit that controls charge of the battery of the vehicle.

In the information processing system according to the above second aspect, the remote operation requested by the user may be an operation of a hazard lamp of the vehicle; and the one or more electronic control units may include an electronic control unit that controls the hazard lamp of the vehicle.

In the information processing system according to the above second aspect, the remote operation requested by the user may be an operation of an alarming horn of the vehicle; and the one or more electronic control units may include an electronic control unit that controls the alarming horn of the vehicle.

A third aspect of the present disclosure provides a user terminal configured to transmit, when a first application program for performing a remote operation of a vehicle is started, an instruction signal to a communication terminal of the vehicle, the instruction signal causing one or more electronic control units mounted on the vehicle to transition from a sleep state to an activated state.

With the present disclosure, it is possible to reduce the delay in a response of the vehicle to a remote operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an overview of a remote system;

FIG. 2 illustrates an example of an electronic control unit (ECU) mounted on a vehicle;

FIG. 3 illustrates an example of the hardware configuration of a communication terminal, a user terminal, and a server device included in the remote system;

FIG. 4 is a block diagram illustrating an example of the functional configuration of a server device according to a first embodiment;

FIG. 5 illustrates an example of information stored in a vehicle management database according to the first embodiment;

FIG. 6 illustrates an example of a sequence of processes executed by constituent elements included in the remote system and the ECU of the vehicle according to the first embodiment;

FIG. 7 is a flowchart illustrating an example of a process routine executed by the server device using reception of a first signal as a trigger according to the first embodiment;

FIG. 8 is a flowchart illustrating an example of a process routine executed by the server device using reception of a second signal as a trigger according to the first embodiment; and

FIG. 9 illustrates an example of a sequence of processes executed by each of a communication terminal, a user terminal, and an ECU when a first application program is started according to a second embodiment.

### DETAILED DESCRIPTION OF EMBODIMENTS

In recent years, application programs that are used to perform a remote operation of a vehicle have been widespread as application programs that can be used on user terminals such as smartphones. When a user performs an operation of a user terminal in which such an application program is installed in order to perform a remote operation of a vehicle, a signal that requests the remote operation is transmitted from the user terminal to a server device. When the signal is received, the server device transmits the signal to a communication terminal of the vehicle linked to the user terminal. When the signal is received, the communication terminal transmits a signal that requests operation corresponding to the remote operation to an in-vehicle electronic control unit (ECU). The ECU controls an in-vehicle device in order to achieve the requested operation. This allows the user of the vehicle to operate the vehicle from a location away from the vehicle. The “server device” is an information processing device that manages a vehicle through mobile communication etc., and is operated by a manufacturer of the vehicle, a company commissioned by the manufacturer, etc., for example.

The remote operation described above is occasionally performed with accessory power (ACC power) of the vehicle turned off. When the ACC power of the vehicle is turned off, the ECU may be in the sleep state. Therefore, it is necessary to cause the ECU to transition from the sleep state to the activated state when the communication terminal of the vehicle receives a signal that requests a remote operation from the server device. As a result, operation corresponding to the requested remote operation cannot be achieved during a period for which the ECU transitions from the sleep state to the activated state, and there occurs a delay in responding to the remote operation.

In view of the above, in an information processing device according to the present disclosure, a control unit detects that an application program (first application program) for a remote operation is started in a user terminal. The control unit transmits an instruction signal to a communication terminal of a vehicle using such detection as a trigger. The instruction signal is a signal that includes an instruction to cause a first ECU to transition from the sleep state to the activated state. The first ECU is an ECU for controlling an in-vehicle device that performs an operation corresponding to a remote operation.

With the present disclosure, it is possible to cause the first ECU to transition from the sleep state to the activated state using start of the first application program as a trigger. Consequently, the first ECU has already transitioned to the activated state after the first application program is started and when an operation by the user of the first application program for a remote operation of a vehicle is performed using the user terminal. As a result, when the communication terminal receives a signal (second signal) that requests a remote operation of a vehicle, the first ECU can immediately control an in-vehicle device that performs an operation corresponding to the remote operation. Hence, it is possible to reduce the delay in response since an operation for a remote operation of a vehicle by the user is performed using the user terminal until the operation corresponding to the remote operation is achieved in the vehicle.

The information processing device according to the present disclosure corresponds to the server device described earlier, for example. The control unit according to the present disclosure corresponds to a processor of the server device such as a central processing unit (CPU) or a digital signal processor (DSP), for example.

The user terminal according to one of the other aspects of the present disclosure is a computer that is used by the user, such as a smartphone, a cellular phone, a tablet terminal, a wearable computer (such as a smart watch), and a personal computer.

Specific embodiments of the present disclosure will be described below with reference to the drawings. The configuration of the following embodiments is illustrative, and the present disclosure is not limited to the configuration of the embodiments.

### First Embodiment

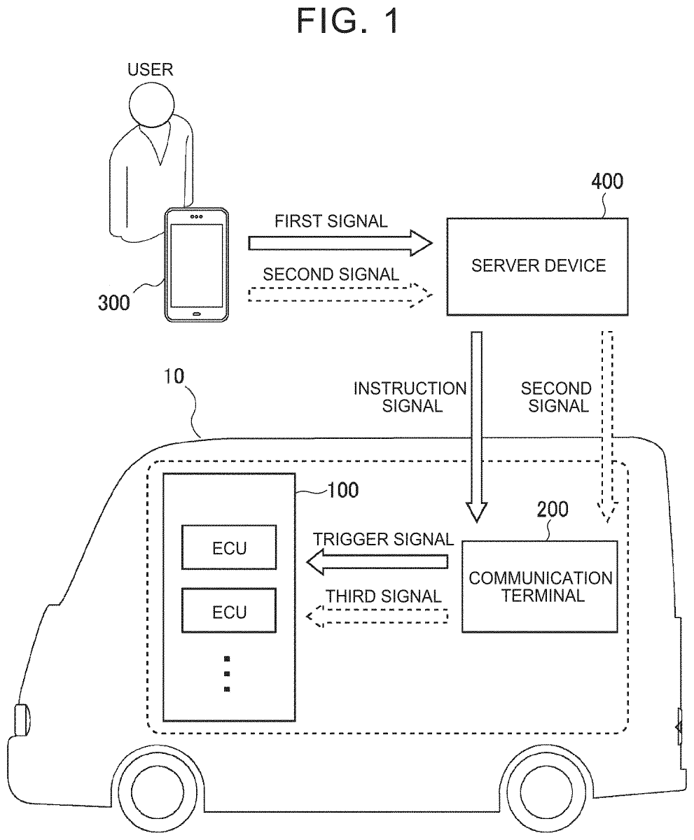

A first embodiment of the present disclosure will be described with reference to FIGS. 1 to 8. In the present embodiment, the information processing device according to the present disclosure is applied to a remote system. The remote system is a system that provides a remote operation service for a vehicle to a user of the vehicle, and is an example of the information processing system according to the present disclosure.

Overall Configuration of System

FIG. 1 illustrates an overview of a remote system to which the information processing device according to the present disclosure is applied. The remote system according to the present embodiment is configured to include a communication terminal 200 mounted on a vehicle 10, a user terminal 300 that is used by a user of the vehicle 10, and a server device 400 installed outside the vehicle 10. In the example illustrated in FIG. 1, one vehicle 10 and one user terminal 300 are illustrated. However, multiple vehicles 10 and multiple user terminals 300 corresponding to respective ones of the vehicles 10 may be under the management of the server device 400.

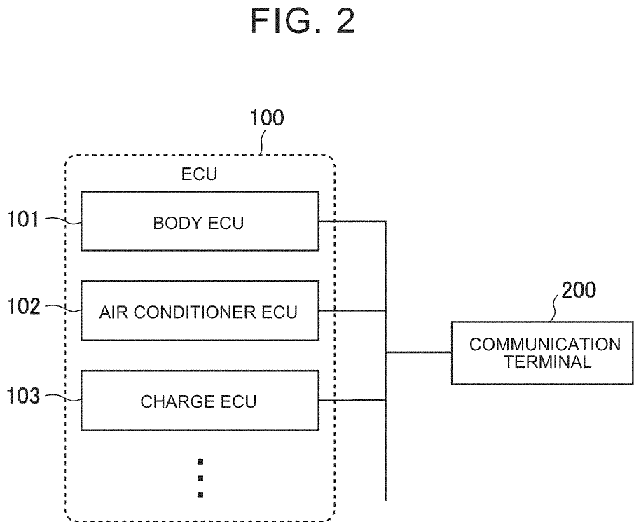

The vehicle 10 according to the present embodiment is a plug-in hybrid electric vehicle (PHEV) or a battery electric vehicle (BEV) that includes a battery that can be charged by an external power source. An electronic control unit (ECU) 100 for controlling various devices mounted on the vehicle 10 is mounted on the vehicle 10. As illustrated in FIG. 2, the ECU 100 includes a plurality of ECUs such as a body ECU 101, an air conditioner ECU 102, and a charge ECU 103, for example. The body ECU 101, the air conditioner ECU 102, and the charge ECU 103 are connected to each other via a vehicle interior network. The vehicle interior network is a network based on a standard such as a Controller Area Network (CAN), a Local Interconnect Network (LIN), or FlexRay, for example.

The body ECU 101 controls a door lock actuator, a power window actuator, a hazard lamp, an alarming horn, etc. The air conditioner ECU 102 controls an air conditioner. The charge ECU 103 controls charge of a battery by an external power source. The ECU 100 that includes the body ECU 101, the air conditioner ECU 102, the charge ECU 103, etc., is in the activated state when an accessory (ACC) power source is energized (e.g. when an ACC switch is turned on), and is in the sleep state when the ACC power source is not energized (e.g. when the ACC switch is turned off). The body ECU 101, the air conditioner ECU 102, and the charge ECU 103 are an example of “one or more ECUs” according to the present disclosure.

In the example illustrated in FIG. 2, a part of the ECU associated with a remote operation to be described later is extracted to be illustrated. The ECU 100 also includes an ECU for controlling a motor, an ECU for controlling a braking device, an ECU for controlling an advanced safety system, etc. The vehicle 10 to which the present disclosure can be applied is not limited to a PHEV or a BEV, and may be a vehicle with an internal combustion engine, a hybrid electric vehicle (HEV), a BEV with an internal combustion engine for power generation, or a fuel cell electric vehicle (FCEV). Accordingly, the type of the ECUs included in the ECU 100 may be different from the example illustrated in FIG. 2.

The communication terminal 200 is mounted on the vehicle 10, and connected to the server device 400 via a network (network N1 to be described later) outside the vehicle. The communication terminal 200 is also connected to the ECU 100 via the vehicle interior network described above. The communication terminal 200 has a function of transmitting, when a second signal (signal that requests a remote operation of the vehicle 10) transmitted from the server device 400 is received, a third signal (signal that requests operation corresponding to the remote operation) to the ECU 100 via the vehicle interior network. In that event, the communication terminal 200 specifies the ECU 100 that controls a target device for the remote operation (device that achieves the operation corresponding to the remote operation), and transmits the third signal to the specified ECU 100.

The communication terminal 200 according to the present embodiment also has a function of transmitting, when an instruction signal (signal that includes an instruction to cause the ECU 100 to transition from the sleep state to the activated state) transmitted from the server device 400 is received, a trigger signal for causing the ECU 100 to transition from the sleep state to the activated state to the ECU 100 via the vehicle interior network, in addition to the function described above. The trigger signal may be transmitted to only the ECU that controls the device that may be a target for the remote operation, among the ECUs included in the ECU 100, or may be transmitted to all the ECUs included in the ECU 100.

The user terminal 300 is a computer that is used by the user of the vehicle 10. An application program (first application program) for performing a remote operation of the vehicle 10 is installed in the user terminal 300. The user terminal 300 has a function of presenting a menu of remote operations of a vehicle to the user, a function of receiving a remote operation selected by the user, a function of transmitting a signal (second signal) that requests the remote operation selected by the user to the server device 400, etc., through execution of the first application program. The menu of remote operations includes an operation to lock a door of the vehicle 10, an operation to unlock a door of the vehicle 10, an operation to open a window of the vehicle 10, an operation to close a window of the vehicle 10, an operation to actuate an air conditioner, an operation to stop actuation of the air conditioner, an operation to turn on a hazard lamp, an operation to turn off the hazard lamp, an operation to sound an alarming horn, an operation to start charge of a battery, an operation to stop charge of the battery, etc., for example. The second signal includes information (operation ID) that identifies a remote operation selected by the user, and information (terminal ID) that identifies the user terminal 300. The second signal may include identification information (user ID) of the user, in place of the terminal ID.

In addition to the functions described above, the user terminal 300 according to the present embodiment also has a function of transmitting a first signal (signal that indicates start of the first application program) to the server device 400 through the network N1 when the first application program is started by a user operation. The first signal according to the present embodiment includes information indicating that the first application program has been started, and a terminal ID (or user ID). Wherein, the start of the first application program includes transitioning the first application program from a sleep state to the activated state, or transition from a state in which the first application program is started in the background to the activated state.

In the present embodiment, it is assumed that the ACC power source of the vehicle 10 is not energized (the ACC switch is turned off) when the first application program is started in the user terminal 300.

The server device 400 is a computer installed outside the vehicle 10 to provide a remote operation service to the user of the vehicle 10. The server device 400 has a function of specifying the vehicle 10 linked to the user terminal 300 (or user) when the second signal transmitted from the user terminal 300 is received, a function of transmitting the second signal to the communication terminal 200 of the specified vehicle 10, etc. The vehicle 10 linked to the user terminal 300 is specified based on the terminal ID (or user ID) included in the second signal.

The server device 400 according to the present embodiment also has a function of detecting start of the first application program based on the first signal transmitted from the user terminal 300 to the server device 400, a function of specifying the vehicle 10 linked to the user terminal 300 (or user), and a function of transmitting an instruction signal (signal that includes an instruction to cause the ECU 100 of the vehicle 10 to transition from the sleep state to the activated state) to the communication terminal 200 of the specified vehicle 10, in addition to the functions described above.

Hardware Configuration of Remote System

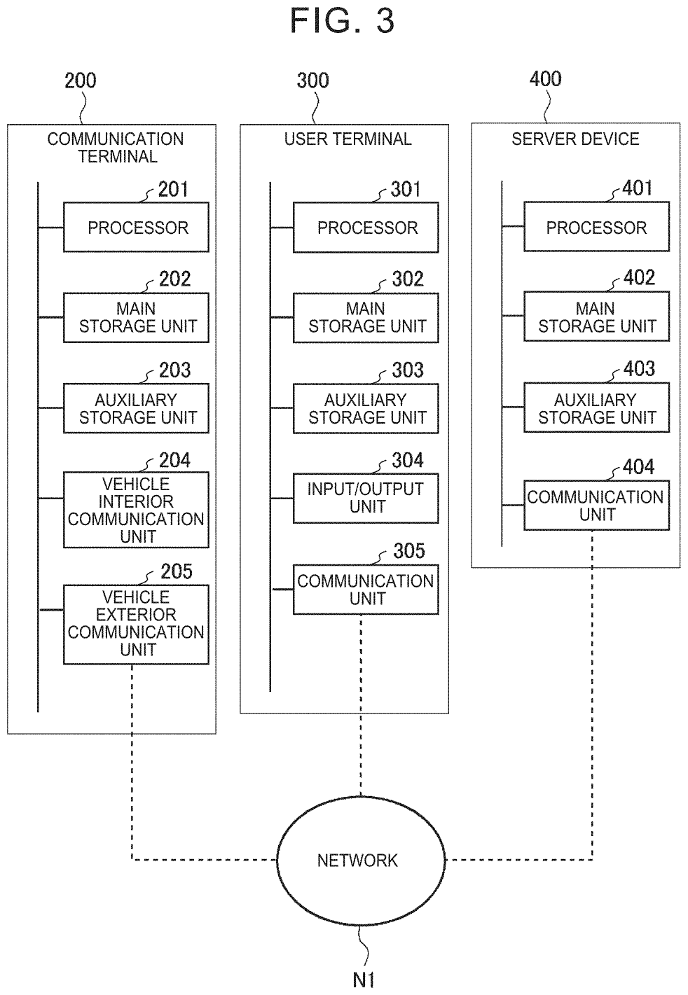

An example of the hardware configuration of each of the communication terminal 200, the user terminal 300, and the server device 400 included in the remote system will be described. FIG. 3 illustrates an example of the hardware configuration of the communication terminal 200, the user terminal 300, and the server device 400 included in the remote system.

The communication terminal 200 is a computer mounted on the vehicle 10. As illustrated in FIG. 3, the communication terminal 200 according to the present embodiment includes a processor 201, a main storage unit 202, an auxiliary storage unit 203, a vehicle interior communication unit 204, a vehicle exterior communication unit 205, etc. In FIG. 3, only hardware constituent elements that perform a process associated with a remote operation, among the hardware constituent elements of the communication terminal 200, are extracted to be illustrated, and hardware constituent elements other than the hardware constituent elements illustrated in FIG. 3 (e.g. hardware constituent elements for providing a multimedia service to an occupant of the vehicle 10, hardware constituent elements that perform a process related to emergency reporting, etc.) may be included in the communication terminal 200.

The processor 201 is a central processing unit (CPU) or a digital signal processor (DSP), for example. The processor 201 controls the communication terminal 200 by performing various computation processes.

The main storage unit 202 is configured to include semiconductor memories such as a random access memory (RAM) and a read-only memory (ROM), for example. The main storage unit 202 provides a storage region for loading a program stored in the auxiliary storage unit 203, and a working region. The main storage unit 202 is used as a buffer for computation processing by the processor 201.

The auxiliary storage unit 203 is an erasable programmable ROM (EPROM) or a hard disk drive (HDD), for example. The auxiliary storage unit 203 can include a removable medium, that is, a portable storage medium. The removable medium is a disk storage medium such as a Universal Serial Bus (USB) memory, a Compact Disc (CD), or a Digital Versatile Disc (DVD), for example. The auxiliary storage unit 203 stores various programs, data that are used by the processor 201 to execute the programs, etc.

The programs stored in the auxiliary storage unit 203 include a program for causing the processor 201 to execute a process associated with a remote operation, in addition to an operating system (OS).

All or a part of the information stored in the auxiliary storage unit 203 may be stored in the main storage unit 202. A part of the information stored in the main storage unit 202 may be stored in the auxiliary storage unit 203.

The vehicle interior communication unit 204 is an interface for connecting the communication terminal 200 to the vehicle interior network. In the present embodiment, the vehicle interior communication unit 204 communicates with the ECU 100 through the vehicle interior network.

The vehicle exterior communication unit 205 is an interface for connecting the communication terminal 200 to the network N1 outside the vehicle. The vehicle exterior communication unit 205 is connected to the network N1 through a mobile communication scheme such as Long Term Evolution (LTE), LTE-Advanced, 5th Generation (5G), and 6th Generation (6G) or a wireless communication scheme such as Wi-Fi (registered trademark), for example. In the present embodiment, the vehicle exterior communication unit 205 communicates with the server device 400 through the network N1.

In the communication terminal 200 configured as described above, when the vehicle exterior communication unit 205 receives an instruction signal transmitted from the server device 400, the processor 201 loads a program stored in the auxiliary storage unit 203 to the main storage unit 202, and executes the program. The program is a program for causing the processor 201 to execute a process associated with a remote operation. The processor 201 controls the vehicle interior communication unit 204 so as to transmit a trigger signal to the ECU 100 through execution of the program described above. The trigger signal is a signal for causing the ECU 100 to transition from the sleep state to the activated state. This allows the ECU 100 to transition from the sleep state to the activated state.

In the communication terminal 200, after the vehicle exterior communication unit 205 receives the instruction signal transmitted from the server device 400 and when the vehicle exterior communication unit 205 receives the second signal transmitted from the server device 400, the processor 201 specifies an ECU that controls a target device for the remote operation based on the operation ID included in the second signal. For example, when the operation ID included in the second signal indicates an operation to open or close a window, an operation to lock or unlock a door, an operation to turn on or turn off the hazard lamp, or an operation to sound the alarming horn, the processor 201 specifies the body ECU 101 as the relevant ECU. When the operation ID included in the second signal indicates an operation to actuate or stop the air conditioner, the processor 201 specifies the air conditioner ECU 102 as the relevant ECU. When the operation ID included in the second signal indicates an operation related to charge of the battery, the processor 201 specifies the charge ECU 103 as the relevant ECU. When the relevant ECU is specified in this manner, the processor 201 transmits the third signal that is a signal that requests operation corresponding to the operation ID, to the relevant ECU through the vehicle interior communication unit 204. In that event, the relevant ECU has already transitioned from the sleep state to the activated state, and therefore the relevant ECU can immediately control the target device for the remote operation.

While the series of processes executed by the communication terminal 200 can be executed through hardware, such processes may be executed through software. The hardware configuration of the communication terminal 200 is not limited to that in the example illustrated in FIG. 3, and constituent elements may be omitted, replaced, or added as appropriate.

The user terminal 300 is a computer that is used by the user of the vehicle 10. Examples of the user terminal 300 include a smartphone, a cellular phone, a tablet terminal, a wearable computer (such as a smart watch), and a personal computer. As illustrated in FIG. 3, the user terminal 300 according to the present embodiment includes a processor 301, a main storage unit 302, an auxiliary storage unit 303, an input/output unit 304, a communication unit 305, etc. In FIG. 3, only hardware constituent elements that perform a process associated with a remote operation, among the hardware constituent elements of the user terminal 300, are extracted to be illustrated, and hardware constituent elements other than the hardware constituent elements illustrated in FIG. 3 (e.g. hardware constituent elements for acquiring the present position of the user terminal 300, hardware constituent elements for outputting sound, etc.) may be included in the user terminal 300.

The processor 301, the main storage unit 302, and the auxiliary storage unit 303 of the user terminal 300 are the same as the processor 201, the main storage unit 202, and the auxiliary storage unit 203, respectively, of the communication terminal 200, and therefore the description thereof will be omitted. The programs stored in the auxiliary storage unit 303 of the user terminal 300 are different from the programs stored in the auxiliary storage unit 203 of the communication terminal 200. That is, the programs stored in the auxiliary storage unit 303 of the user terminal 300 include the first application program in addition to the OS.

The input/output unit 304 receives an input operation performed by the user, and presents information to the user. The input/output unit 304 is configured to include a touch panel display and a control circuit for the touch panel display, for example. In the present embodiment, the input/output unit 304 causes the touch panel display to display a menu screen for a plurality of application programs (including the first application program) installed in the user terminal 300, and receives an operation by the user to select an application program. When the first application program is selected by the user, the input/output unit 304 causes the touch panel display to display a menu screen for remote operations, and receives an operation by the user to select a remote operation.

The communication unit 305 is an interface for connecting the user terminal 300 to the network N1 through a wire or wirelessly. In the present embodiment, the communication unit 305 communicates with the server device 400 through the network N1. The communication unit 305 is a network interface card (NIC), an optical communication circuit, a wireless communication circuit, etc., for example.

In the user terminal 300 configured as described above, when the user performs an operation to select the first application program on the menu screen for application programs displayed on the touch panel display of the input/output unit 304, the processor 301 loads the first application program stored in the auxiliary storage unit 303 to the main storage unit 302, and executes the first application program (starts the first application program). When the first application program is started, the processor 301 transmits the first signal that includes information indicating that the first application program has been started and the terminal ID (or the user ID) to the server device 400 through the communication unit 305.

The processor 301 causes the touch panel display of the input/output unit 304 to display a menu screen for remote operations at the same time as or after execution of the process of transmitting the first signal. In the present embodiment, when the first application program is started, the processor 301 causes the touch panel display of the input/output unit 304 to display a screen that includes information indicating the state of the vehicle 10 (e.g. the open/closed state of the windows, the locked/unlocked state of the doors, the on/off state of the hazard lamp, the sounding/non-sounding state of the alarming horn, the temperature in the vehicle cabin, the remaining capacity of the battery, etc.) and a button for calling up a menu screen for remote operations. When the button for calling up a menu screen for remote operations is operated by the user on the screen, the processor 301 causes the touch panel display of the input/output unit 304 to display a menu screen for remote operations. The information related to the state of the vehicle 10 may be acquired by the processor 301 from the communication terminal 200 of the vehicle 10 through the server device 400 when the first application program is started. The information related to the state of the vehicle 10 may be transmitted from the communication terminal 200 to the user terminal 300 via the server device 400 at the timing when the ACC power source of the vehicle 10 is turned off, and stored in the auxiliary storage unit 303 etc. of the user terminal 300.

When the user performs an operation to select a desired remote operation when a menu screen for remote operations is displayed on the touch panel display of the input/output unit 304, the processor 301 transmits the second signal that includes the operation ID of the selected remote operation and the terminal ID (or the user ID) to the server device 400 through the communication unit 305.

While the series of processes executed by the user terminal 300 can be executed through hardware, such processes may be executed through software. The hardware configuration of the user terminal 300 is not limited to that in the example illustrated in FIG. 3, and constituent elements may be omitted, replaced, or added as appropriate.

The server device 400 is a computer installed outside the vehicle 10, and is an example of the “information processing device” according to the present disclosure. The server device 400 according to the present embodiment provides a remote operation service to the user of the vehicle 10. The server device 400 is operated by a manufacturer of the vehicle 10, a company commissioned by the manufacturer of the vehicle 10, etc., for example. As illustrated in FIG. 3, the server device 400 includes a processor 401, a main storage unit 402, an auxiliary storage unit 403, a communication unit 404, etc. In FIG. 3, only hardware constituent elements that perform a process associated with a remote operation, among the hardware constituent elements of the server device 400, are extracted to be illustrated, and hardware constituent elements other than the hardware constituent elements illustrated in FIG. 3 (e.g. hardware constituent elements for providing a service other than a remote operation etc.) may be included in the server device 400.

The processor 401, the main storage unit 402, the auxiliary storage unit 403, and the communication unit 404 of the server device 400 are the same as the processor 301, the main storage unit 302, the auxiliary storage unit 303, and the communication unit 305, respectively, of the user terminal 300, and therefore the description thereof will be omitted. The programs stored in the auxiliary storage unit 403 of the server device 400 are different from the programs stored in the auxiliary storage unit 303 of the user terminal 300. The programs stored in the auxiliary storage unit 403 of the server device 400 include a program for providing a remote operation service to the user of the vehicle 10, in addition to the OS.

The hardware configuration of the server device 400 is not limited to that in the example illustrated in FIG. 3, and constituent elements may be omitted, replaced, or added as appropriate.

Functional Configuration of Server Device

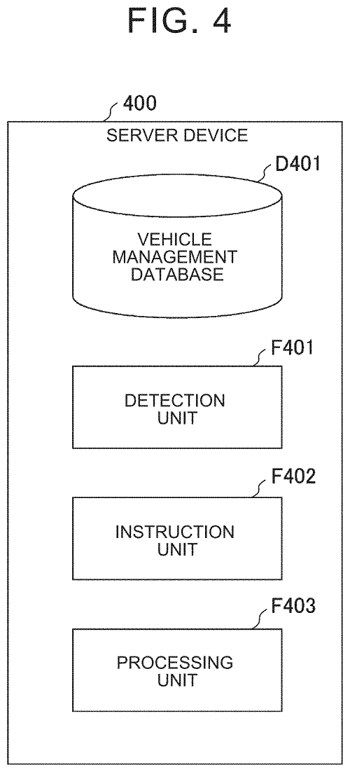

An example of the functional configuration of the server device 400 according to the present embodiment will be described. FIG. 4 is a block diagram illustrating an example of the functional configuration of the server device 400 according to the present embodiment. The server device 400 according to the present embodiment includes a vehicle management database D401, a detection unit F401, an instruction unit F402, and a processing unit F403 as functional constituent elements of the server device 400.

The vehicle management database D401 is constructed by a database management system (DBMS) managing data stored in the auxiliary storage unit 403. The DBMS is a program executed by the processor 401 of the server device 400. The vehicle management database D401 according to the present embodiment stores information that links the user terminal 300 and the vehicle 10 to each other.

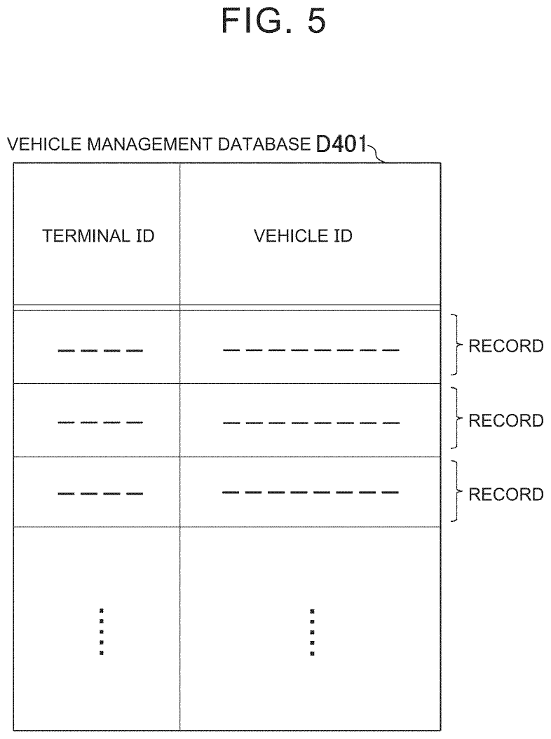

An example of the information stored in the vehicle management database D401 will be described with reference to FIG. 5. As illustrated in FIG. 5, the vehicle management database D401 according to the present embodiment stores a plurality of records corresponding to respective ones of the vehicles 10 under the management of the server device 400. The records in the vehicle management database D401 include a terminal ID field and a vehicle ID field. The configuration of the records stored in the vehicle management database D401 is not limited to that in the example illustrated in FIG. 5, and fields can be added, changed, or deleted as appropriate.

The terminal ID field stores the terminal ID of the user terminal 300 that is used by the user. The vehicle ID field stores identification information (vehicle ID) of the vehicle 10 that the user of the user terminal 300 has an ownership right to or a right to use. The records in the vehicle management database D401 may include a user ID field in place of the terminal ID field. In that case, identification information (user ID) of the user may be registered in the user ID field. The vehicle ID of the vehicle 10 that the user has an ownership right to or a right to use may be registered in the vehicle ID field. Information for specifying the communication terminal 200 of the vehicle 10 that the user has an ownership right to or a right to use may be registered in the vehicle ID field.

Returning to the description of FIG. 4, the detection unit F401, the instruction unit F402, and the processing unit F403 are implemented as the processor 401 of the server device 400 loads a program for providing a remote operation service to the user of the vehicle 10 onto the main storage unit 402 and executes the program. The processor 401 that implements the detection unit F401, the instruction unit F402, and the processing unit F403 corresponds to the “processor” of the “information processing device” according to the present disclosure.

The detection unit F401 detects start of the first application program in the user terminal 300. In the present embodiment, when the communication unit 404 of the server device 400 receives the first signal transmitted from the user terminal 300, the detection unit F401 detects start of the first application program based on the first signal. In other words, the detection unit F401 determines that the first application program has been started at the timing when the communication unit 404 receives the first signal. When the detection unit F401 detects start of the first application program, the terminal ID included in the first signal is passed from the detection unit F401 to the instruction unit F402.

The instruction unit F402 transmits an instruction signal to the communication terminal 200 of the vehicle 10 using detection of start of the first application program by the detection unit F401 as a trigger. Specifically, the instruction unit F402 first accesses the vehicle management database D401, and specifies a record in which information that coincides with the terminal ID received from the detection unit F401 is registered in the terminal ID field. The instruction unit F402 specifies the vehicle 10 linked to the user terminal 300 in which the first application program has been started based on the vehicle ID registered in the vehicle ID field of the specified record. The instruction unit F402 transmits an instruction signal to the communication terminal 200 of the specified vehicle 10 through the communication unit 404. The instruction signal is a signal that includes an instruction to cause the ECU 100 of the vehicle 10 to transition from the sleep state to the activated state.

When the communication unit 404 of the server device 400 receives a second signal transmitted from the user terminal 300, the processing unit F403 transmits the second signal to the communication terminal 200 of the vehicle 10. The second signal is a signal that requests a remote operation selected by the user, and includes the operation ID of the remote operation selected by the user and the terminal ID of the user terminal 300, as described earlier. When such a second signal is received by the communication unit 404, the processing unit F403 first accesses the vehicle management database D401, and specifies a record in which information that coincides with the terminal ID included in the second signal is registered in the terminal ID field. The processing unit F403 specifies the vehicle 10 (the vehicle 10 as a target for a remote operation) linked to the user terminal 300 that transmitted the second signal based on the vehicle ID registered in the vehicle ID field of the specified record. The processing unit F403 transmits the second signal to the communication terminal 200 of the specified vehicle 10 through the communication unit 404.

Any of the detection unit F401, the instruction unit F402, and the processing unit F403, or a part thereof, may be implemented by a hardware circuit such as an application specific integrated circuit (ASIC) or a field programmable gate array (FPGA). The functional constituent elements of the server device 400 are not limited to those in the example illustrated in FIG. 4, and the constituent elements may be omitted, replaced, or added as appropriate.

Process Flow

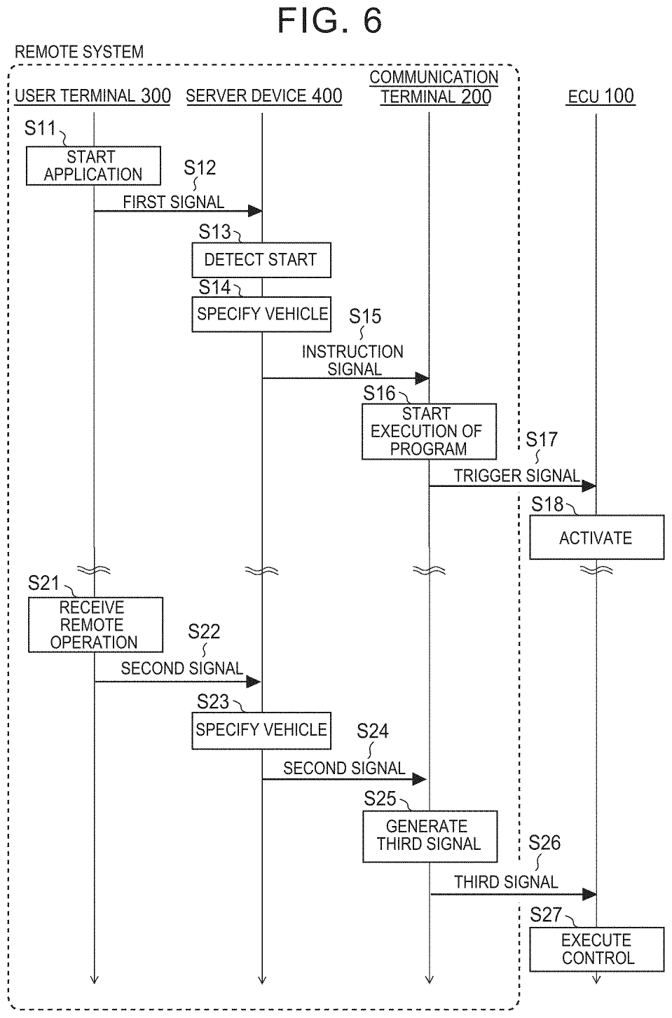

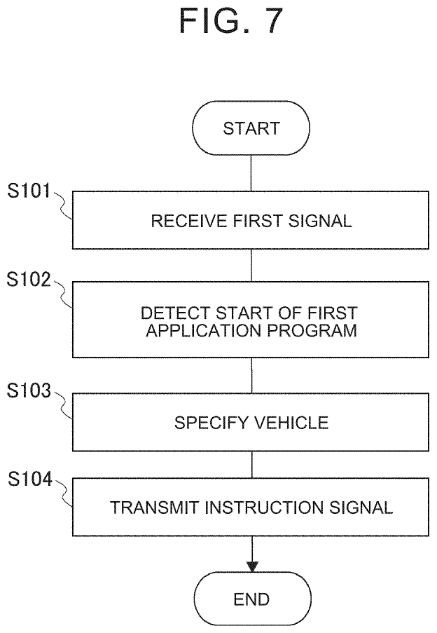

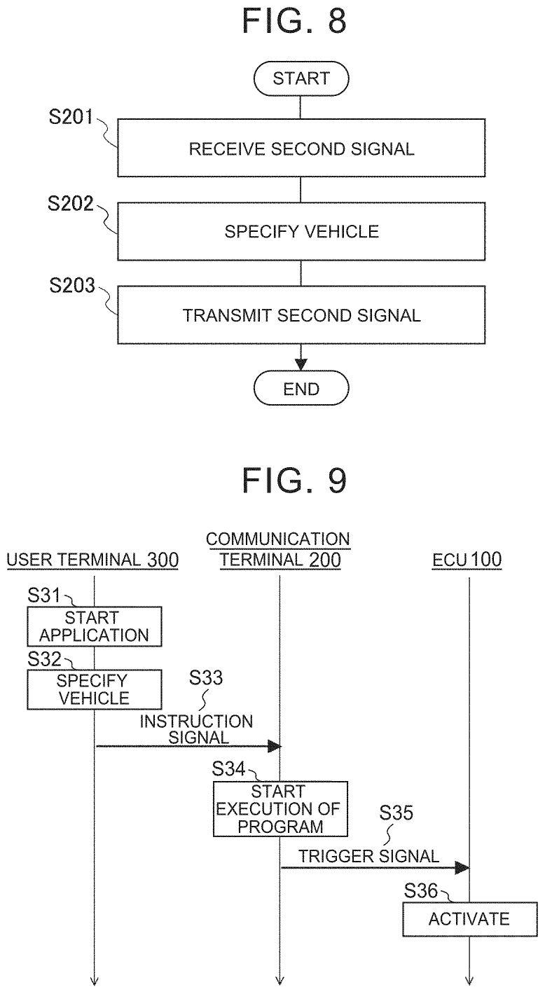

Next, the flow of processes related to a remote operation according to the present embodiment will be described with reference to FIGS. 6 to 8. FIG. 6 illustrates an example of a sequence of processes executed by the constituent elements of the remote system and the ECU 100 of the vehicle 10. FIG. 7 is a flowchart illustrating an example of a process routine executed by the server device 400 using reception of the first signal as a trigger. FIG. 8 is a flowchart illustrating an example of a process routine executed by the server device 400 using reception of the second signal as a trigger. It is assumed that the ACC power source of the vehicle 10 is not energized (the ACC switch is turned off) and, accordingly, the ECU 100 of the vehicle 10 is in the sleep state at the time when the processes in FIGS. 6 and 7 are started.

In FIG. 6, when the user performs an operation to select the first application program with the input/output unit 304 of the user terminal 300 displaying a menu screen for application programs on the touch panel display, the processor 301 loads the first application program stored in the auxiliary storage unit 303 to the main storage unit 302, and executes the first application program. Consequently, the first application program is started (S11).

When the first application program is started in the user terminal 300, the processor 301 of the user terminal 300 transmits the first signal that includes information indicating that the first application program has been started and the terminal ID to the server device 400 through the communication unit 305 (S12).

When the communication unit 404 of the server device 400 receives the first signal, the processor 401 of the server device 400 detects start of the first application program (S13). The processor 401 of the server device 400 specifies the vehicle 10 linked to the user terminal 300 in which the first application program has been started based on the terminal ID included in the first signal and the information stored in the vehicle management database D401 (S14).

When the vehicle 10 linked to the user terminal 300 in which the first application program has been started is specified, the processor 401 of the server device 400 transmits an instruction signal to the communication terminal 200 of the specified vehicle 10 through the communication unit 404 (S15). The instruction signal is a signal that includes an instruction to cause the ECU 100 of the vehicle 10 to transition from the sleep state to the activated state.

When the vehicle exterior communication unit 205 receives the instruction signal in the communication terminal 200 of the vehicle 10, the processor 201 loads a program stored in the auxiliary storage unit 203 to the main storage unit 202, and starts execution of the program (S16). The program that is executed in this case is a program for causing the processor 201 to execute a process associated with a remote operation. The processor 201 transmits a trigger signal to the ECU 100 through execution of the program described above (S17). The trigger signal is a signal for causing the ECU 100 to transition from the sleep state to the activated state. The trigger signal is transmitted through the vehicle interior communication unit 204. Consequently, the ECU 100 transitions from the sleep state to the activated state (S18).

When the user performs an operation to select a desired remote operation with the input/output unit 304 displaying a menu screen for remote operations on the touch panel display in the user terminal 300 after the ECU 100 of the vehicle 10 is caused to transition from the sleep state to the activated state, the processor 301 receives the remote operation selected by the user (S21).

When the processor 301 of the user terminal 300 receives the remote operation selected by the user, the processor 301 transmits the second signal that includes the operation ID of the remote operation selected by the user and the terminal ID of the user terminal 300 to the server device 400 through the communication unit 305 (S22).

When the communication unit 404 of the server device 400 receives the second signal, the processor 401 of the server device 400 specifies the vehicle 10 linked to the user terminal 300 that has originated the second signal based on the terminal ID included in the second signal and the information stored in the vehicle management database D401 (S23). When the vehicle 10 linked to the user terminal 300 that has originated the second signal is specified, the processor 401 of the server device 400 transmits the second signal to the communication terminal 200 of the specified vehicle 10 through the communication unit 404 (S24).

When the vehicle exterior communication unit 205 receives the second signal in the communication terminal 200 of the vehicle 10 linked to the user terminal 300 that has originated the second signal, the processor 201 generates the third signal based on the operation ID included in the second signal (S25). The third signal is a signal that requests an operation corresponding to the operation ID. When the third signal is generated, the processor 201 of the communication terminal 200 transmits the third signal to the ECU 100 through the vehicle interior communication unit 204. In that event, the processor 201 specifies an ECU that controls a target device for the remote operation based on the operation ID, and transmits the third signal to the specified ECU.

When the third signal transmitted from the communication terminal 200 is received, the ECU controls the target device for the remote operation in accordance with the third signal (S27). In that event, the ECU has already been in the activated state through the processes in S17 and S18 described above, and therefore can immediately execute control for the target device for the remote operation. In the present embodiment, in particular, a screen that includes information indicating the state of the vehicle 10 and a button for calling up a menu screen for remote operations is first displayed on the touch panel display of the input/output unit 304 in the user terminal 300 in which the first application program has been started. When the button for calling up a menu screen for remote operations is operated by the user on the screen, a menu screen for remote operations is displayed on the touch panel display. Hence, a temporal delay occurs since the first application program is started in the user terminal 300 until an operation to select a remote operation is performed by the user. Consequently, the ECU 100 can be reliably brought into the activated state before an operation to select a remote operation is performed by the user, even when a time lag occurs since the first application program is started in the user terminal 300 until the ECU 100 transitions from the sleep state to the activated state. As a result, it is possible to reduce a response delay time since the user performs an operation to select a remote operation until a target device for the remote operation actually operates.

Next, a process routine that is executed by the server device 400 using reception of the first signal transmitted from the user terminal 300 by the server device 400 as a trigger will be described with reference to FIG. 7. While the subject to execute the process routine illustrated in FIG. 7 is the processor 401 of the server device 400, the functional constituent elements of the server device 400 are treated as the subject to execute the process routine in the description here.

In FIG. 7, when the communication unit 404 of the server device 400 receives the first signal transmitted from the user terminal 300 (step S101), the detection unit F401 determines that the first application program has been started in the user terminal 300 at the timing when the communication unit 404 receives the first signal. By making such a determination, the detection unit F401 detects start of the first application program in the user terminal 300 (step S102). When execution of the process in step S101 is ended, the detection unit F401 passes the terminal ID included in the first signal to the instruction unit F402. The instruction unit F402 executes the process in step S103 using reception of the terminal ID as a trigger.

In step S103, the instruction unit F402 specifies the vehicle 10 linked to the user terminal 300 in which the first application program has been started. Specifically, the instruction unit F402 accesses the vehicle management database D401, and specifies a record in which information that coincides with the terminal ID received from the detection unit F401 is registered in the terminal ID field. The instruction unit F402 specifies the vehicle 10 linked to the user terminal 300 in which the first application program has been started based on the vehicle ID registered in the vehicle ID field of the specified record. When execution of the process in step S103 is ended, the instruction unit F402 executes the process in step S104.

In step S104, the instruction unit F402 transmits an instruction signal to the communication terminal 200 of the vehicle 10 specified in step S103 through the communication unit 404. The instruction signal is a signal that includes an instruction to cause the ECU 100 of the vehicle 10 to transition from the sleep state to the activated state. After the process in step S104 is executed, execution of the present process routine is ended.

In the communication terminal 200 that has received the instruction signal transmitted from the instruction unit F402, the processes in S16 and S17 in FIG. 6 described earlier are executed, and this causes the ECU 100 of the vehicle 10 to transition from the sleep state to the activated state. Consequently, the ECU 100 of the vehicle 10 can be brought into the activated state before an operation to select a desired remote operation is performed by the user of the vehicle 10 using the user terminal 300.

Next, a process routine that is executed by the server device 400 using reception of the second signal transmitted from the user terminal 300 by the server device 400 as a trigger will be described with reference to FIG. 8. While the subject to execute the process routine illustrated in FIG. 8 is the processor 401 of the server device 400, the functional constituent elements of the server device 400 are treated as the subject to execute the process routine in the description here.

In FIG. 8, when the communication unit 404 of the server device 400 receives the second signal transmitted from the user terminal 300 (step S201), the processing unit F403 of the server device 400 specifies the vehicle 10 linked to the user terminal 300 that has transmitted the second signal (step S202). Specifically, the processing unit F403 accesses the vehicle management database D401, and specifies a record in which information that coincides with the terminal ID included in the second signal is registered in the terminal ID field. The processing unit F403 specifies the vehicle 10 (the vehicle 10 as a target for the remote operation) linked to the user terminal 300 that has transmitted the second signal based on the vehicle ID registered in the vehicle ID field of the specified record. After execution of the process in step S202 is ended, the processing unit F403 executes the process in step S203.

In step S203, the processing unit F403 transmits the second signal to the communication terminal 200 of the vehicle 10 specified in step S202 through the communication unit 404. The signal transmitted from the processing unit F403 to the communication terminal 200 may be a signal that is different from the second signal. The second signal is a signal that requests a remote operation selected by the user, and includes the operation ID of the remote operation selected by the user and the terminal ID of the user terminal 300, as described earlier. On the contrary, the signal transmitted from the processing unit F403 to the communication terminal 200 may be a signal that includes only the operation ID of the remote operation. After the process in step S203 is executed, execution of the present process routine is ended.

In the communication terminal 200 that has received the second signal transmitted from the processing unit F403, the processes in S25 and S26 in FIG. 6 described earlier are executed, and this causes the ECU 100 of the vehicle 10 to control a target device for the remote operation. In that event, the ECU 100 has already been in the activated state, and therefore control for a target device for the remote operation by the ECU 100 is immediately performed.

With the embodiment described above, the ECU 100 of the vehicle 10 can be caused to transition from the sleep state to the activated state at the timing when the first application program is started in the user terminal 300. Consequently, when the user performs a remote operation through the user terminal 300 after the first application program is started, it is possible to suppress a response delay time since the user performs an operation for the remote operation until the target device for the remote operation actually operates.

### Second Embodiment

In the first embodiment described earlier, an instruction signal is transmitted from the server device 400 to the communication terminal 200 of the vehicle 10 when the first application program is started in the user terminal 300. In the present embodiment, on the contrary, an instruction signal is transmitted from the user terminal 300 to the communication terminal 200 of the vehicle 10 when the first application program is started in the user terminal 300.

In the user terminal 300 according to the present embodiment, when the user performs an operation to select the first application program on a menu screen for application programs displayed on the touch panel display of the input/output unit 304, the processor 301 loads the first application program stored in the auxiliary storage unit 303 to the main storage unit 302, and executes the first application program (starts the first application program). When the first application program is started, the processor 301 transmits an instruction signal to the communication terminal 200 of the vehicle 10 through the communication unit 305. The instruction signal according to the present embodiment is a signal that includes an instruction to cause the ECU 100 of the vehicle 10 to transition from the sleep state to the activated state.

In order to directly transmit the instruction signal described above from the user terminal 300 to the communication terminal 200, information for specifying the vehicle linked to the user terminal 300 needs to be held in the user terminal 300. Thus, the auxiliary storage unit 303 of the user terminal 300 according to the present embodiment stores the information for specifying the vehicle 10 linked to the user terminal 300. The auxiliary storage unit 303 may store information for specifying the communication terminal 200 of the vehicle 10 linked to the user terminal 300, in place of the information for specifying the vehicle 10 linked to the user terminal 300.

Process Flow

The flow of processes related to a remote operation according to the present embodiment will be described with reference to FIG. 9. FIG. 9 illustrates an example of a sequence of processes executed by the user terminal 300, the communication terminal 200, and the ECU 100 when the first application program is started in the user terminal 300.

In FIG. 9, when the user performs an operation to select the first application program in a state where the input/output unit 304 of the user terminal 300 displays a menu screen for application programs on the touch panel display, the processor 301 loads the first application program stored in the auxiliary storage unit 303 to the main storage unit 302, and executes the first application program. Consequently, the first application program is started (S31).

When the first application program is started in the user terminal 300, the processor 301 of the user terminal 300 specifies the vehicle 10 linked to the user terminal 300 based on the information stored in the auxiliary storage unit 303 (S32). The processor 301 transmits an instruction signal to the communication terminal 200 of the specified vehicle 10 through the communication unit 305 (S33). The instruction signal is a signal that includes an instruction to cause the ECU 100 of the vehicle 10 linked to the user terminal 300 to transition from the sleep state to the activated state.

When the vehicle exterior communication unit 205 receives the instruction signal described above in the communication terminal 200 of the vehicle 10 linked to the user terminal 300, the processor 201 loads a program stored in the auxiliary storage unit 203 to the main storage unit 202, and starts execution of the program (S34). The program executed in this case is a program for causing the processor 201 to execute a process associated with a remote operation. The processor 201 transmits a trigger signal to the ECU 100 through execution of the program described above (S35). The trigger signal is a signal for causing the ECU 100 to transition from the sleep state to the activated state. The trigger signal is transmitted through the vehicle interior communication unit 204. Consequently, the ECU 100 transitions from the sleep state to the activated state (S36).

As the transmission of the second signal to the communication terminal 200 of the vehicle 10, the second signal may be directly transmitted from the user terminal 300 to the communication terminal 200 after the ECU 100 of the vehicle 10 is caused to transition from the sleep state to the activated state. Further, the second signal may be transmitted from the user terminal 300 to the communication terminal 200 via the server device 400 as in the first embodiment.

With the embodiment described above, the ECU 100 of the vehicle 10 can be caused to transition from the sleep state to the activated state based on the instruction signal directly transmitted from the user terminal 300 to the communication terminal 200 when the first application program is started in the user terminal 300. This may also make it possible to cause the ECU 100 of the vehicle 10 to transition from the sleep state to the activated state at an earlier timing.

Others

The embodiments described above are merely illustrative, and the present disclosure may be modified as appropriate to be implemented without departing from the spirit and scope of the present disclosure. In addition, the processes and the components described in the present disclosure can be combined as desired unless any technical contradiction occurs. Further, the processes described as being performed by a single device may be executed in a distributed manner by a plurality of devices. Meanwhile, the processes described as being performed by different devices may be executed by a single device. The hardware components that implement functions in the computer system are flexibly changeable.

The present disclosure can also be implemented by supplying a computer with a computer program that implements the functions described in the embodiments or modifications described above and causing one or more processors of the computer to read and execute the program. Such a computer program may be provided to the computer by a non-transitory computer-readable storage medium that is connectable to the system bus of the computer, or may be provided to the computer via a network. The non-transitory computer-readable storage medium is a storage medium that can store information such as data and programs through electrical, magnetic, optical, mechanical, or chemical action and that can be read by a computer etc. Such a non-transitory computer-readable storage medium may be a disk of any type such as a magnetic disk (such as a floppy (registered trademark) disk or an HDD) or an optical disc (such as a CD-ROM, a DVD, or a Blu-ray disc), for example. The non-transitory computer-readable storage medium may also be a medium such as a read only memory (ROM), a random access memory (RAM), an EPROM, an EEPROM, a magnetic card, a flash memory, an optical card, or a solid state drive (SSD).

What is claimed is:

1. An information processing device comprising a processor configured to:
detect start of a first application program in a user terminal, the first application program being used to perform a remote operation of a vehicle; and
transmit, when the start of the first application program is detected, an instruction signal that causes one or more electronic control units mounted on the vehicle to transition from a sleep state to an activated state to a communication terminal of the vehicle.

2. The information processing device according to claim 1, wherein:
the processor is configured to detect the start of the first application program based on a first signal transmitted from the user terminal to the information processing device; and
the first signal is transmitted from the user terminal to the information processing device when the first application program is started.

3. The information processing device according to claim 2, further comprising a storage unit configured to store information that indicates corresponding between the user terminal and the vehicle to each other,
wherein the processor is configured to:
specify the vehicle corresponded to the user terminal based on the information stored in the storage unit when the information processing device receives the first signal transmitted from the user terminal; and
transmit the instruction signal to the communication terminal of the specified vehicle.

4. The information processing device according to claim 3, wherein the processor is configured to transmit, after transmitting the instruction signal to the communication terminal and when the information processing device receives a second signal that requests a remote operation of the vehicle from the user terminal, the second signal for requesting the remote operation of the vehicle to the communication terminal of the vehicle corresponded to the user terminal.

5. The information processing device according to claim 1, wherein the one or more electronic control units are configured to include an electronic control unit that controls a power window actuator of the vehicle.

6. The information processing device according to claim 1, wherein the one or more electronic control units are configured to include an electronic control unit that controls an air conditioning device of the vehicle.

7. The information processing device according to claim 1, wherein the one or more electronic control units are configured to include an electronic control unit that controls a door lock actuator of the vehicle.

8. The information processing device according to claim 1, wherein the one or more electronic control units are configured to include an electronic control unit that controls charge of a battery of the vehicle.

9. The information processing device according to claim 1, wherein the one or more electronic control units are configured to include an electronic control unit that controls a hazard lamp of the vehicle.

10. The information processing device according to claim 1, wherein the one or more electronic control units are configured to include an electronic control unit that controls an alarming horn of the vehicle.

11. An information processing system comprising:
a user terminal configured such that a first application program to be used to perform a remote operation of a vehicle is installed;
a server device configured to communicate with the user terminal; and
a communication terminal mounted on the vehicle and configured to communicate with the server device, wherein:
the user terminal is configured to transmit a first signal to the server device when the first application program is started;
the server device is configured to detect start of the first application program based on the first signal, and the server device is further configured to transmit an instruction signal that causes one or more electronic control units mounted on the vehicle to transition from a sleep state to an activated state to the communication terminal of the vehicle when the start of the first application program is detected; and
the communication terminal is configured to transmit a signal for causing the one or more electronic control units to transition from the sleep state to the activated state to the one or more electronic control units when the instruction signal is received.

12. The information processing system according to claim 11, wherein the server device is configured to further include a storage unit that stores information that indicates corresponding between the user terminal and the vehicle to each other, the server device being configured to:
specify the vehicle corresponded to the user terminal based on the information stored in the storage unit when the first signal is received; and
transmit the instruction signal to the communication terminal of the specified vehicle.

13. The information processing system according to claim 12, wherein the user terminal is configured to:
receive an operation by a user to request a remote operation of the vehicle after transmitting the first signal; and
transmit a second signal that requests the remote operation of the vehicle to the server device;
the server device is configured to transmit, upon receiving the second signal from the user terminal, the second signal for requesting the remote operation of the vehicle to the communication terminal of the vehicle corresponded to the user terminal; and
the communication terminal is configured to transmit, upon receiving the second signal, a signal that requests an operation corresponding to the remote operation to the one or more electronic control units.

14. The information processing system according to claim 13, wherein:
the remote operation requested by the user is an operation of a power window of the vehicle; and
the one or more electronic control units include an electronic control unit that controls a power window actuator of the vehicle.

15. The information processing system according to claim 13, wherein:
the remote operation requested by the user is an operation of an air conditioning device of the vehicle; and
the one or more electronic control units include an electronic control unit that controls the air conditioning device.

16. The information processing system according to claim 13, wherein:
the remote operation requested by the user is an operation to lock or unlock a door of the vehicle; and
the one or more electronic control units include an electronic control unit that controls a door lock actuator of the vehicle.

17. The information processing system according to claim 13, wherein:
the remote operation requested by the user is an operation to charge a battery of the vehicle; and
the one or more electronic control units include an electronic control unit that controls charge of the battery of the vehicle.

18. The information processing system according to claim 13, wherein:
the remote operation requested by the user is an operation of a hazard lamp of the vehicle; and
the one or more electronic control units include an electronic control unit that controls the hazard lamp of the vehicle.

19. The information processing system according to claim 13, wherein:
the remote operation requested by the user is an operation of an alarming horn of the vehicle; and
the one or more electronic control units include an electronic control unit that controls the alarming horn of the vehicle.

20. A user terminal configured to transmit, when a first application program for performing a remote operation of a vehicle is started, an instruction signal to a communication terminal of the vehicle, the instruction signal causing one or more electronic control units mounted on the vehicle to transition from a sleep state to an activated state.
